(19) United States
(12) Patent Application Publication
(10) Pub. No.: US 2008/0031628 A1
(43) Pub. Date: Feb. 7, 2008

(54) Wireless/Optical Transceiver Devices

(76) Inventors: Milan Dragas, London (GB); Martin Cryan, Cornwall (GB)

Correspondence Address: WELSH & KATZ, LTD, 120 S RIVERSIDE PLAZA, 22ND FLOOR, CHICAGO, IL, 60606, US

(21) Appl. No.: 11/587,366

(22) PCT Filed: Apr. 28, 2005
(86) PCT No.: PCT/GB05/01632

§ 371 Date: Aug. 8, 2007

(30) Foreign Application Priority Data
May 1, 2004 (GB) 0409855.4

(51) Int. Cl. H04B 10/02

(52) U.S. Cl. 398/116; 398/115

(57) ABSTRACT

An optical/wireless transceiver device is operable to convert an input optical signal to an outgoing radio frequency signal, and to convert an incoming radio frequency signal to an output optical signal.

### FIELD OF THE INVENTION

The present invention relates to wireless/optical transceiver devices.

### BACKGROUND OF THE INVENTION

Achieving conversion of signals between the optical and radio frequency (RF) domains is a continuing challenge, particularly in the communications arena. Various ways of combining optical and radio microwave circuits have been suggested, as will be described below.

One of main areas in which optical devices have been combined with microwave circuits is that of radio frequency compatibility (EMC) measurements. In such applications, an antenna is connected to an optical device, typically a photodiode or electro-optic modulator which is then connected to an optical fiber. The antenna senses the field strength at a particular position and this signal is modulated on to an optical carrier signal and the modulated signal is transmitted along the optical fiber. This has the major advantage that the fiber interacts only very weekly with the measured radio frequency fields and thus measurements can be made without changing the field itself. One example of such an application is given in “Non-invasive E-Field Probe Measurement using an Integrated Optical E-field Sensor”, 10^{th} International Conference on Optical Fiber Sensors OFS-10, SPIE 2360, Glasgow, 49-52, October 1994, Meier, Kostrzwa, Petermann, Seebass, Wust, and Fahling.

In terms of communications related areas the integration of photodiodes and planar antennas has been described in Hirata and Nagatsuma, “120 Ghz millimeter-wave antenna for integrated photonic transmitter. In such a system, a photodiode is integrated with a planar slot antenna to produce an optical-to-electrical transmitting antenna.

Other similar examples are described in “Design, Fabrication And Characterisation Of Normal-incidence 1.56-¹M Multiple-Quantum-Well Asymmetric Fabry-Perot Modulators For Passive Picocells”, C P Liuya, A J Seeds, J S Chadha, P N Stavrinou, G Parry, M Whitehead, A Krysa, and J S Roberts, IEICE Trans. Electron., Vol. E85-C, No. 1 January 2002, and “Bi-Directional Transmission of Broadband 5.2 GHz Wireless Signals Over Fiber Using a Multiple-Quantum-Well Asymmetric Fabry-Perot Modulator/Photodetector”, C. Liu, A. Seeds; J. Chadha, P. Stavrinou, G. Parry, M. Whitehead, A. Krysa, J. Roberts, OFC 2003.

Here, a particular type of optical device known as an Asymmetric Fabry-Perot Modulator (AFPM) is connected to a microstrip patch antenna for use in wireless communications. The AFPM requires some form of external light source, for example a laser device. However, the AFPM is a very specialised optical device, which has taken a number of years to develop, is not commercially available and is very expensive.

The Active Integrated Atenna (AIA) concept has been in use in microwave engineering for a number of years; for example, see K. C. Gupta and P. S. Hall (eds), “Analysis and design of integrated circuit antenna modules”, (John Wiley, New York, 1999), and M. J. Cryan, P. S. Hall, K. S. H. Tsang and J. Sha, “Integrated active antenna with full duplex operation”, IEEE Trans. Microwave Theory and Tech, Vol. 45, No. 10 October 1997. An AIA is the result of integration of electronic components such as diodes and transistors with planar antennas to produce highly multifunctional modules. Some work has been done on the integration of optoelectronic devices with antennas, but this has concentrated on the receiver-side e.g., photodiodes, as described above.

It is desirable to provide a transceiver that includes a Photonic Active Integrated Antenna (PhAIA). Such a transceiver has wide application in mass markets due to the very low cost, low weight and conformability. The main initial application is anticipated to be in wireless communication systems based around the IEEE802.11b/a standards operating at 2.4 GHz and 5.2 GHz respectively. There are two main applications within this area, firstly to extend the range of existing WiFi hotspot coverage. Secondly, in future WiFi systems a central base station will be connected to a network of picocell-PhAIA base stations by the existing in-building multimode fiber (MMF) network. The main advantage of this “wireless-over-fiber” concept is that once converted into the optical domain the signal can be transmitted over very large distances with essentially zero attenuation, since typical MMF fibres losses are <1 dB/km. Thus, complete coverage within a large building or even over a campus size network could be achieved from one central base station—dramatically reducing the costs of installation. The other compelling advantage is that the system will be data format independent. This is provided that the optical devices can operate at the appropriate carrier frequency; the fiber network will always be able to transmit the modulated signal, up to and possibly above 100 GHz.

It is therefore desirable to provide an optical/RF transceiver module that can meet this need

### SUMMARY OF THE PRESENT INVENTION

According to one aspect of the present invention, there is provided an optical/wireless transceiver device operable to convert an input optical signal to an outgoing radio frequency signal, and to convert an incoming radio frequency signal to an output optical signal.

### BRIEF DESCRIPTION OF THE DRAWINGS

FIGS. 1 and 2 illustrate a first embodiment of the present invention;

FIG. 3 illustrates a second embodiment of the present invention;

FIG. 4 illustrates a third embodiment of the present invention;

FIG. 5 illustrates a fourth embodiment of the present invention;

FIGS. 6 and 7 show a fifth embodiment of the present invention;

FIG. 8 shows a sixth embodiment of the present invention;

FIG. 9 shows a seventh embodiment of the present invention;

FIG. 10 illustrates an eighth embodiment of the present invention;

FIG. 11 illustrates an application incorporating devices embodying the present invention; and

FIG. 12 illustrates another application incorporating devices embodying the present invention.

### DETAILED DESCRIPTION OF THE PREFERRED EMBODIMENTS

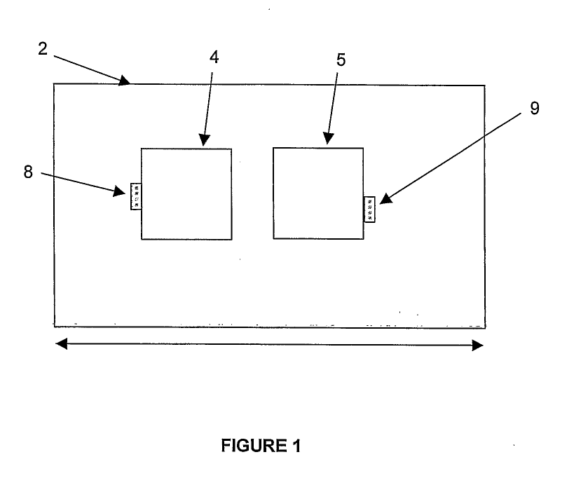

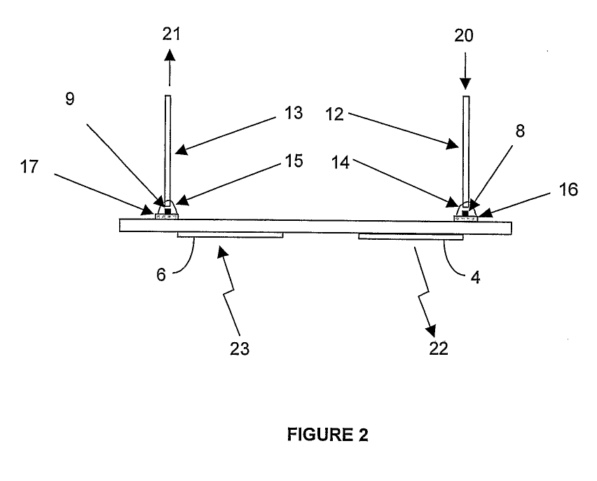

FIGS. 1 and 2 illustrate, in plan and side views respectively, a first transceiver 1 embodying the present invention. In this first embodiment, a substrate 2 carries a transmit antenna 4 and a receive antenna 5.

A photodiode (PD) 8 is located adjacent the transmit antenna 4 on the substrate 2, and is electrically connected with the transmit antenna 4. A bias voltage connection of the photodiode 8 is connected with the transmit antenna 4.

A vertical cavity semiconductor laser (VCSEL) device 9 is provided on the substrate adjacent the receive antenna 5, and is electrically connected with the receive antenna 5. The receive antenna 5 is connected with a bias voltage connection of the VCSEL 9.

The photodiode 8 and the VCSEL device 9 are supplied with electrical current from a power supply (not shown for the sake of clarity).

In the example shown in FIGS. 1 and 2, the photodiode 8 and VCSEL device 9 are carried on an opposite side of the substrate to the antenna 4 and 5, using respective microstrip carriers 16 and 17. The photodiode 8 and VCSEL device 9 are connected with respective optical fibres 12 and 13, and are secured to the fibres using, for example, an optically transparent epoxy glue 14 and 15.

The photodiode 8 and VCSEL device 9 are positioned with respect to the transmit and receive antenna 4 and 5 so that the antenna and the devices are electrically impedance matched. As is known, the impedance of a patch antenna varies over the antenna, and so embodiments of the present invention can make use of this characteristic to provide impedance matching. Impedance matching leads to improved power transfer between the optical devices and the antennas.

Operation of the embodiment of FIGS. 1 and 2 will now be described. For transmission of radio frequency signals from the transmit antenna 4, a modulated optical signal 20 is supplied to the photodiode 8 via the optical fiber 12. This modulated optical signal 20 comprises an optical carrier signal, modulated by the radio frequency signal to be transmitted. The modulation of the optical signal 20 causes the photocurrent of the photodiode 8 to vary, thereby supplying a radio frequency signal to the transmit antenna. This electrical signal results in a radio frequency transmission 22 being emitted from the transmit antenna 4.

When a radio frequency signal 22 is received by the receive antenna 23, the bias current signal of the VCSEL device 9 is caused to vary. This in turn causes the optical output of the VCSEL device 9 to be modulated in dependence upon the received radio frequency signal. The modulated optical signal 21 output from the VCSEL device 9 is transmitted through the optical fiber 13.

In such a manner, the device shown in FIGS. 1 and 2 is able to provide an optical/radio frequency transceiver device that converts outgoing optical signals to radio frequency signals, and converts received radio frequency signals to a modulated optical signal.

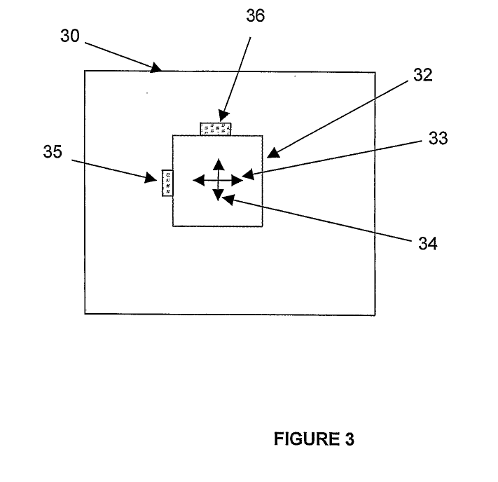

FIG. 3 illustrates a plan view of a second transceiver device embodying the present invention. A substrate 30 carries, on a first side thereof, a patch antenna 32. The patch antenna 32 has two orthogonal axes of polarisation 34 and 35. A photodiode 36 and a VCSEL device 37 are positioned adjacent the patch antenna 32, on a second side of the substrate 30, and are connected electrically to the antenna 32. The photodiode 36 and the VCSEL device 37 are provided with optical fiber connections, and operate in a manner similar to that shown in and described with reference to FIGS. 1 and 2.

The photodiode 36 is connected to receive radio frequency signals in a first axis of polarisation. The VCSEL device 37 is connected so that radio frequency signals are transmitted in the direction parallel to the other axis 35 of polarisation of the patch antenna 32.

Such a device enables a single patch antenna to be used for both transmission and reception of radio frequency signals. Polarised patch antennas are able to perform both transmission and reception without interference between the transmitted and received signals.

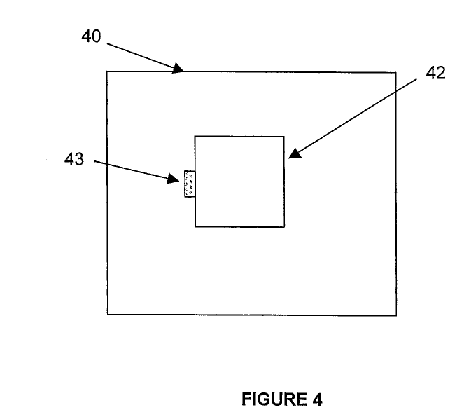

FIG. 4 illustrates a third transceiver device which embodies the present invention. A substrate 40 carries a patch antenna 42 and a dual-purpose transmit/receive VCSEL device 43. The patch antenna is carried on one side of the substrate, with the VCSEL device 43 on the other. The VCSEL device 43 is electrically connected with the patch antenna 42, and is optically connected with an optical fiber, in a manner similar to that shown in FIG. 2.

The VCSEL device 43 in the third transceiver operates both as a transmitting device and as a receiving device. Dual functionality is obtained by etching away some of the top mirrors of the VCSEL device to allow some incident light into the cavity. When the VCSEL device 43 is reversed biased, the incident light will be detected and the device will operate as a photodiode. When the VCSEL device 43 is forward biased, laser action occurs and the device will transmit light. A dual function VCSEL device is described in “Dual-Purpose VCSELs for Short-Haul Bidirectional Communication Links”, Milan Dragas et al IEEE Photonics Technology Letters, Vol. 11, No. 12, December 1999.

Accordingly, in a transmitting mode, the VCSEL device 43 is reversed biased, and an input optical signal (received from an optical fiber, not shown for clarity) modulated by the desired radio frequency signal serves to modulate the bias voltage signal of the resulting effective photodiode.

In a receiving mode, the VCSEL device 43 is forward biased, such that a received radio frequency signal incident on the antenna causes the optical signal produced by the VCSEL device 43 to be modulated. The modulated optical signal is supplied to the optical fiber.

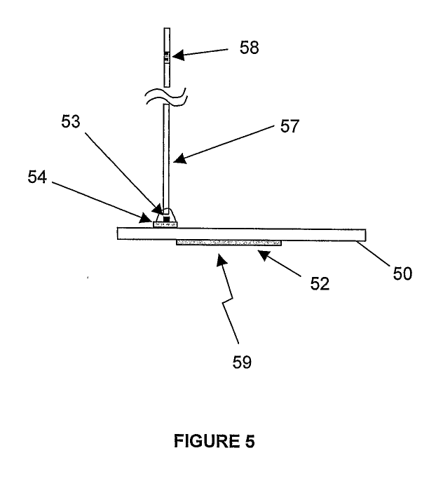

FIG. 5 illustrates, in side view, a fourth transceiver embodying the present invention.

A substrate 50 carries, on one side thereof, a patch antenna 52, as before. On the other of the substrate 50, a VCSEL device 53 is located adjacent the patch antenna on a microstrip carrier 54. The VCSEL device 53 and patch antenna 52 are electrically connected to one another, as in the example embodiment shown in FIG. 4. As in the embodiment of FIG. 4, a dual purpose VCSEL device is used in the embodiment of FIG. 5.

However, in the FIG. 5 embodiment, an external cavity mode locked VCSEL device 53 is used. The external cavity mode locked device makes use of a Bragg grating 58 located at a distance from the VCSEL device 53 along an optical fiber 57 to which the VCSEL device is coupled. The effect of the Bragg grating is to cause the VCSEL device 53 to emit a modulated light signal. In the embodiment of FIG. 5, the Bragg grating is chosen such that the optical signal output from the VCSEL device 53 is modulated at a radio frequency similar to the frequency of the received radio frequency signal received by the antenna 52. This received radio frequency signal injection locks the VCSEL device 53 to produce an optical signal modulated at the received frequency, with the added modulation of the incoming data signal.

The embodiment of the FIG. 5 effectively amplifies the incoming RF signal by injection locking the mode locked VCSEL device 53 to the incoming signal. Such amplification effectively increases the range over which the optical signal can be transmitted from the device.

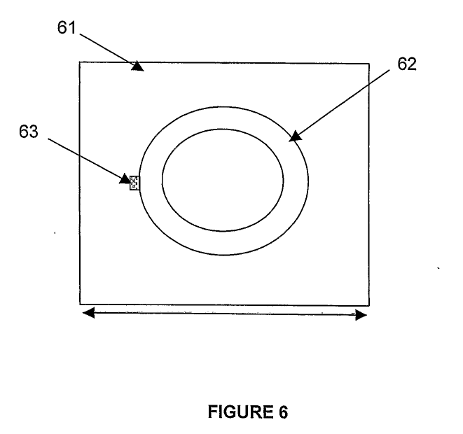

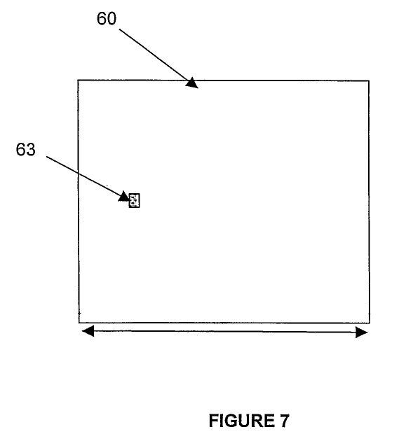

FIGS. 6 and 7 illustrate a fifth embodiment of the present invention in which a substrate 60 carries an antenna on one side. The antenna comprises a ground plane 61 and a slot ring 62. The ground plane 61 and slot ring 62 form a small scale antenna to which a VCSEL device 63 is connected.

In this embodiment, the antenna is formed directly on a semiconductor substrate such as InP or GaAs. This enables monolithic fabrication of both the laser device (and photodiode device) and the antenna at the same time which could drastically reduce manufacturing costs.

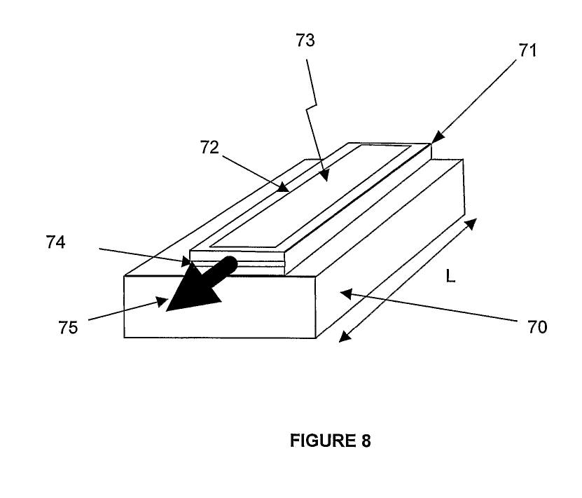

FIG. 8 illustrates a monolithic semiconductor laser device which embodies a further aspect of the present invention, and that provides a monolithic photonic active integrated antenna. The embodiment of FIG. 8 comprises a substrate 70 which carries a semiconductor laser device 71. The laser device 71 includes an active region 74 from which an optical signal 75 is emitted when the device is biased correctly with an electrical signal received via a metalisation layer 72. In the embodiment of FIG. 8, the metalisation layer is of such a size that it operates as a patch antenna itself, and so radio frequency radiation incident upon the metalisation layer serves to modulate the output optical signal 75.

A design such as that shown in FIG. 8 enables a small scale photonic active integrated antenna to be provided, by making use of the electrical characteristics of the monolithic laser device to provide the electrical patch antenna.

Such devices are aimed at applications in the millimeter wave bands where the wavelength of radio frequency radiation is approaching the size of the optical device.

The requirement for a patch antenna is that it is of a length approximately equal to half the wavelength of the incoming radio frequency signal. Therefore, it is necessary to match the size of the metalisation layer of the monolithic device to the incoming frequency. For example, if the incoming radio frequency is at 60 GHz, then its free space wavelength is approximately 5 mm. However, a typical material from which monolithic devices are produced is InP, which has a refractive index of 3.2, meaning that the incoming signal has a wavelength in the device of 1.56 mm. Accordingly, the length of the metalisation layer of the monolithic device needs to be approximately 0.75 mm.

Typical device lengths are 0.3-0.5 mm, which is close enough to the half wavelength requirement for the metalisation layer to act as an antenna. In addition there are various known techniques in antenna design, which enables the required length to be reduced to the size of these typical devices.

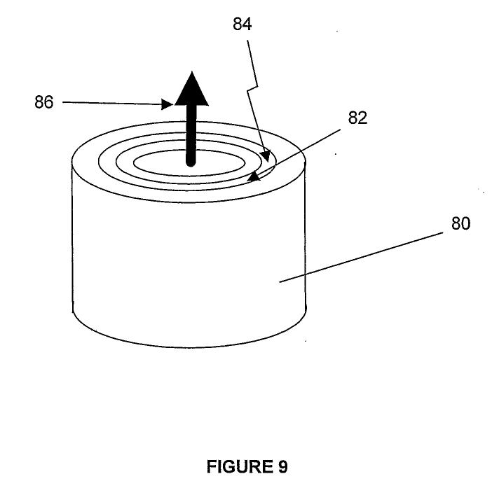

Similar techniques can be used for VCSELS, which have cylindrical geometry and thus are more suited to slot-ring, or ring type antennas. FIG. 9 illustrates a VCSEL device 80 having a slot antenna 82 formed on an upper surface of the device. The slot ring antenna 82 receives a radio frequency signal 84 and this signal is used to modulate an output optical signal 86.

In FIG. 9, a slot-ring antenna is integrated on the top surface of the VCSEL device 80. A ring antenna may also be used, and by utilising higher order resonance of the antenna modulation response in the millimeter ranges can be obtained.

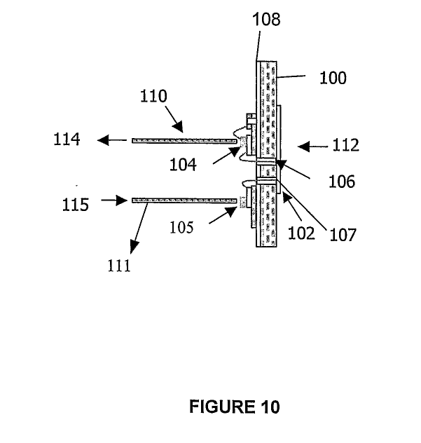

FIG. 10 illustrates another embodiment of the present invention, which comprises a substrate 100, a patch antenna 102 mounted on a first side of the substrate 100, and a ground plane 108 mounted on a second side of the substrate 100.

A VCSEL device 104 is mounted on a microstrip carrier on the ground plane 108, and is electrically connected to the patch antenna 102 using a wire 106. An optical fiber 110 is coupled with the VCSEL device 104, for transmission of optical signals 114 from the VCSEL device 104. The VCSEL device can be any device as described above with reference to the other embodiments of the present invention.

A photodiode device 105 is provided on the ground plane 108, and is connected with the antenna 102. An optical fiber 111 is connected with the photodiode device 105, and supplies a high power optical signal 115 to the photodiode device 105. The photodiode device 105 converts the input optical signal to an electrical current for supply to the VCSEL device. The photodiode 105 therefore acts as a power supply for the VCSEL device 104.

The transceiver shown in FIG. 10 therefore does not need a separate power supply, but can rather receive power from an optical signal supplied via the optical fiber used for transmission of the modulated signals. Such an example has the advantage that only the optical connections are therefore required, and no separate power supply connections are needed. This greatly simplifies the installation of transceivers. The requirement for battery or mains connection is removed, which greatly reduces cost, and also and simplifies the system.

The techniques described with reference to FIG. 10 are applicable to the embodiment of FIGS. 1 and 2, in which case, when the photodiode receives the modulated light signal, a dc current is produced which is normally not used. With appropriate choice of VCSEL device this photodiode device current can be used to bias the VCSEL device. This again results in transceiver device which needs no external power in order to operate.

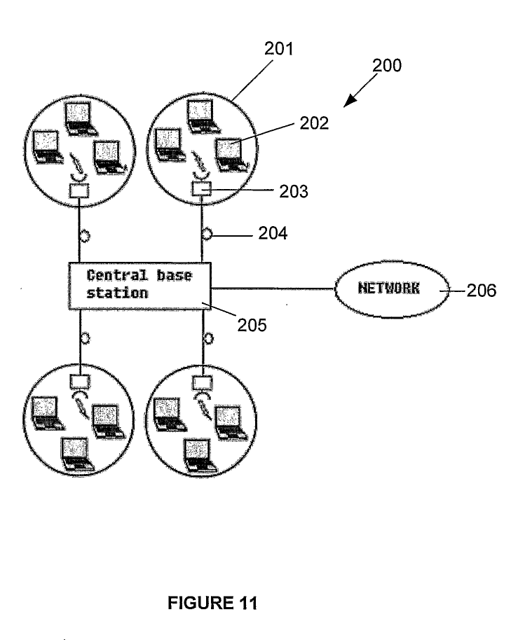

FIG. 11 illustrates a wireless LAN (Local area network) system 200, for example in accordance with wireless communications as described in the IEEE standard IEEE802.11. The system 200 defines a number of picocells 201 which each serves a number of wireless devices 202. Each picocell 201 is served by a transceiver device 203 embodying the present invention. The transceiver device is connected to a central base station 205 via an optical fiber 204. The transceiver device converts optical signals from the base station 205 into radio frequency signals for transmission to the wireless devices 202. The transceiver device 203 also receives radio frequency signals from the wireless devices 202 and converts them to optical signals for transmission to the base station. The base station 205 is connected as part of a wider network 206.

Such a system that makes use of transceivers embodying the present invention can provide a wireless LAN over an increased area by making use of optical fiber connection between transceivers.

The transceiver device 203 used in picocell is as described above in relation to specific embodiments of the present invention, and enables a cost-effective and relatively simple wireless network to be provided. For example, in an office building, each office could be provided with a transceiver embodying the present invention which would effectively provide a picocell for that office. The transceiver can then be connected to one another, and to a network server, using optical fibres which are installed in the fabric of the building. In new buildings in particular, this is a particularly cost effective solution as many new office building using optical fibres as a matter of course.

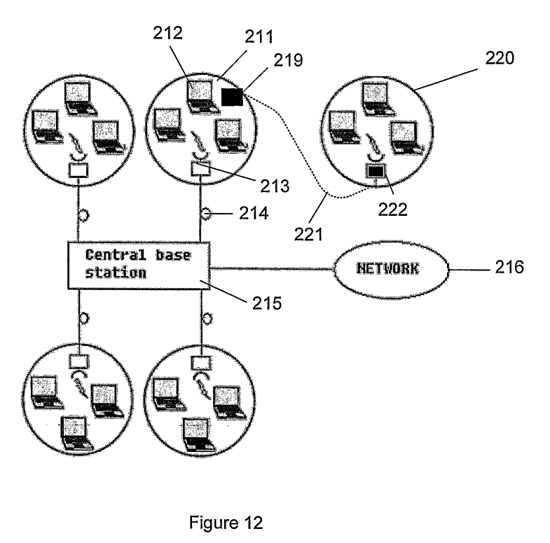

FIG. 12 illustrates another network application of the devices embodying the present invention. The system is similar to that described with reference to FIG. 11, and comprises a number of picocells 211 each of which includes a radio frequency transceiver 213 for communicating radio frequency signals to and from wireless devices 212. In the system of FIG. 12, the transceivers can be conventional radio frequency transceivers, or can be devices embodying the present invention.

In the system of FIG. 12, one of the picocells is provided with a transceiver device 219 embodying the present invention. This transceiver device 219 serves to communicate using radio frequency signals with the transceiver device 213 which defines the picocell. The transceiver device 219 is connected, via an optical fiber 221 to a further transceiver device 222 embodying the present invention. The further transceiver device 222 defines a further picocell 220, and communicates with a further group of wireless devices.

The system of FIG. 12 enables the wireless network to be extended easily and relatively cheaply, since an existing base station can be used for the extension.

1. An optical/wireless transceiver device comprising circuitry operable to convert an input optical signal to an outgoing radio frequency signal, and to convert an incoming radio frequency signal to an output optical signal.

2. An optical/wireless transceiver device as claimed in claim 1, comprising:
a planar transmit antenna for transmission of an outgoing radio frequency signal;
a photodiode device connected to receive an input optical signal, and operable to supply a radio frequency signal to the transmit antenna;
a planar receive antenna for reception of an incoming radio frequency signal;
a semiconductor laser device connected to receive an incoming radio frequency signal from the receive antenna, and operable to produce a modulated output optical signal in dependence upon the incoming radio frequency signal.

3. An optical/wireless transceiver device as claimed in claim 1, comprising:
a planar antenna for transmission of an outgoing radio frequency signal and reception of an incoming radio frequency signal;
a photodiode device connected to receive an input optical signal, and operable to supply a radio frequency signal to the antenna; and
a semiconductor laser device connected to receive an incoming radio frequency signal from the antenna, and operable to produce a modulated output optical signal in dependence upon the incoming radio frequency signal.

4. A device as claimed in claim 3, wherein the photodiode device is connected to supply the outgoing radio frequency signal to the antenna in a first axis of polarisation of the antenna, and the laser device is connected to receive the incoming radio frequency signal in a second axis of polarisation of the antenna.

5. A device as claimed in claim 4, wherein the first and second axes of polarisation of the antenna are mutually perpendicular.

6. A device as in claim 3, wherein the semiconductor laser device is chosen from a group comprising a vertical cavity semiconductor laser VCSEL device, and a semiconductor edge emitting laser EEL device.

7. An optical/wireless transceiver device as claimed in claim 1, comprising:
a planar antenna for transmission of an outgoing radio frequency signal and reception of an incoming radio frequency signal; and
a dual purpose vertical cavity semiconductor laser device connected to receive an incoming radio frequency signal from the antenna, and operable to produce a modulated output optical signal in dependence upon the incoming radio frequency signal, and connected to receive an input optical signal and operable to supply an outgoing radio frequency signal to the antenna.

8. A device as in claim 2, wherein the antenna is chosen from a group comprising a microstrip patch antenna, a slot-ring antenna, a ring antenna, and a planar dipole antenna.

9. A device as in claim 3, further comprising a substrate on which the antenna and the device are mounted.

10. A device as claimed in claim 9, wherein the antenna is mounted on a first side of the substrate, and the device is mounted on a second different, side of the substrate.

11. A device as in claim 10 wherein the substrate is formed of a semiconductor material.

12. A device as claimed in claim 11, wherein the semiconductor material is chosen from a group comprising gallium arsenide, silicon, indium phosphide, silicon germanium, gallium nitride, and silicon carbide.

13. A radio frequency receiver device comprising a semiconductor laser device having a metal electrode, wherein the metal electrode provides an antenna of the receiver device.

14. A device as claimed in claim 13, wherein the metal electrode is operable to receive an incoming radio frequency signal, and is connected to modulate an optical output of the laser device in dependence upon a received radio frequency signal.

15. A device as in claim 13, wherein the semiconductor laser device is chosen from a group comprising a vertical cavity semiconductor laser VCSEL device, a dual purpose vertical cavity semiconductor laser DP-VCSEL device, and an edge emitting laser EEL device.

16. A radio frequency transmitter device comprising an optical component having a metal electrode, wherein the metal electrode provides an antenna of the transmitter device.

17. A device as claimed in claim 16, wherein the optical component is connected to receive an input optical signal, and is operable to transmit an outgoing radio frequency signal from the metal electrode.

18. A device as in claim 16, wherein the optical component is chosen from a group comprising a photodiode, and a dual purpose vertical cavity semiconductor laser DP-VCSEL device.

19. A transceiver device as in claim 3, comprising an optical device which is operable to receive an optical signal and to convert that optical signal to a supply current for any other optical device in the transceiver device.

20. A device as in claim 7, wherein the antenna is chosen from a group comprising a microstrip patch antenna, a slot-ring antenna, a ring antenna, and a planar dipole antenna.

21. A device as claimed in claim 8, further comprising a substrate on which the antenna and the device are mounted.
